(19) United States
(12) Patent Application Publication
(10) Pub. No.: US 2026/0350341 A1
(43) Pub. Date: Nov. 5, 2026

(54) METHODS OF MAKING CONSTRUCTIONS INCLUDING COMMUNICATION DEVICES

(71) Applicant: Avery Dennison Corporation, Mentor, OH (US)

(72) Inventors: Eric L. BARTHOLOMEW, Mill Hall, PA (US); Vivek PANDEY, Willoughby, OH (US)

(21) Appl. No.: 19/663,993

(22) Filed: Apr. 30, 2026

Related U.S. Application Data
(60) Provisional application No. 63/797,235, filed on Apr. 30, 2025.

(51) Int. Cl. G06K 19/077; H01Q 1/22

(52) U.S. Cl. CPC G06K 19/07798; G06K 19/0776; H01Q 1/2283

(57) ABSTRACT

Methods for making constructions that include communication devices, as well as the resulting constructions, are disclosed. In some implementations, a communication device may be formed on an elastomeric carrier using an adhesive. Deformation of the elastomeric carrier, such as stretching, may cause debonding of the adhesive, thereby facilitating release of the communication device from the carrier.

### CROSS-REFERENCE TO RELATED APPLICATIONS

The present application claims priority to U.S. Provisional Application No. 63/797,235 filed Apr. 30, 2025, the entire contents and disclosures of which are hereby incorporated by reference.

### FIELD OF INVENTION

The present disclosure relates generally to methods of making constructions including a communication device. Also disclosed are constructions including communication devices.

### BACKGROUND

Communication devices such as radio-frequency identification devices (RFID) have become increasingly prevalent in various industries for tracking, identifying, and managing items. RFID systems typically consist of tags or labels containing antennas and microchips, which can be attached to objects and read by RFID readers. These systems offer advantages over traditional barcode technology, including the ability to read multiple tags simultaneously and without direct line of sight.

Conventional RFID tags typically incorporate a carrier, commonly made of polyethylene terephthalate (PET), to support the antenna and microchip components. The antenna, typically constructed from conductive films such as aluminum, is deposited onto this carrier. While this structure provides stability and protection for the RFID components, it also introduces certain limitations.

The presence of a carrier in RFID tags contributes to increased production costs and results in a bulkier overall structure. This bulkiness can be particularly problematic when RFID tags are integrated into labels. The thickness of the carrier-based RFID tag may create noticeable protrusions or irregularities on the surface of the labeled item, potentially detracting from the aesthetic appeal of the product packaging.

Attempts have been made to address these issues by developing carrier-free RFID tags. One approach involves depositing an adhesive onto a release film carrier, such as a polyethylene terephthalate (PET) film coated with a release agent like silicone, and then constructing the antenna on this adhesive layer. However, disadvantageously, the adhesive tends to de-wet and spread beyond its intended boundaries, making it difficult to maintain the precise shape and dimensions of the antenna structure.

There exists a need for improved methods of manufacturing RFID tags that can overcome the limitations of both carrier-based and existing carrier-free approaches. An ideal solution would at least one of minimize production costs, reduce bulk, maintain the integrity of the antenna structure, and allow for seamless integration with products such as labels without compromising aesthetics.

### SUMMARY

This summary is provided to introduce a selection of concepts in a simplified form that are further described below in the Detailed Description. The present disclosure relates to methods of manufacturing constructions on elastomeric carriers to form radio frequency communication devices, such as RFID devices.

In general, the method relates to making a construction including a communication device on an elastomeric carrier. The construction may be assembled on an elastomeric carrier and includes the antenna or an inlay comprising an antenna and chip. The construction may subsequently be released by stretching the elastomeric carrier to cause debonding. Accordingly, using an elastomeric carrier in the method described herein may enable temporary support during antenna formation, while subsequent stretching-induced debonding provides a controlled and non-destructive release mechanism. This approach can reduce damage to the antenna and facilitate transfer to a protective film.

In a first aspect, a method of making a construction including a communication device is provided. The method includes depositing a first adhesive onto a first surface of an elastomeric carrier, wherein the first adhesive is deposited in the shape of an antenna, disposing a conductive film onto the first adhesive, cutting the conductive film to form a shape of an antenna, disposing a protective film onto the first surface of the elastomeric carrier, thereby sandwiching the antenna between the elastomeric film and a second adhesive coated on a surface of the protective film; and, stretching the elastomeric carrier to cause the first adhesive to debond from the elastomeric carrier. In some embodiments, the stretching of the elastomeric carrier may cause a portion of the second adhesive to debond from the elastomeric carrier. The elastomeric carrier is selected from the group consisting of natural rubber, synthetic rubber, or thermoplastic elastomers.

In another aspect, a method of making a construction including a communication device is provided. The method comprises depositing a first adhesive onto a first surface of an elastomeric carrier, wherein the first adhesive is deposited in the shape of an antenna, solidifying the first adhesive, wherein solidifying the first adhesive comprises at least one of UV curing and drying the first adhesive, forming an antenna on the solidified first adhesive, disposing a protective film onto the first surface of the elastomeric carrier, thereby sandwiching the antenna between the elastomeric film and a second adhesive coated on a surface of the protective film; and stretching the elastomeric carrier to cause the first adhesive to debond from the elastomeric carrier. In some embodiments, the stretching of the elastomeric carrier may cause a portion of the second adhesive to debond from the elastomeric carrier. The elastomeric carrier is selected from the group consisting of natural rubber, synthetic rubber, or thermoplastic elastomers.

In another aspect, a construction is provided. The construction includes a communication device including an antenna and a chip, a first adhesive layer supporting the antenna, and a protective film having a second adhesive coating, wherein the communication device is sandwiched between the second adhesive on the protective film and the elastomeric carrier; and wherein the first adhesive layer is configured to debond from the elastomeric carrier upon stretching of the elastomeric carrier.

The foregoing general description of the illustrative embodiments and the following detailed description thereof are merely exemplary embodiments of the teachings of this disclosure and are not restrictive.

### BRIEF DESCRIPTION OF FIGURES

Advantages of embodiments of the present disclosure will be apparent from the following detailed description of the exemplary embodiments thereof, which description should be considered in conjunction with the accompanying drawings in which like numerals indicate like elements, in which:

FIG. 1a is a schematic illustration showing a side view of a communication device being constructed according to aspects described herein.

FIG. 1b is a schematic illustration showing a side view of a communication device being constructed according to aspects described herein.

FIG. 1c is a schematic illustration showing a side view of a communication device being constructed according to aspects described herein.

FIG. 1d is a schematic illustration showing a side view of a communication device being constructed according to aspects described herein.

FIG. 1e is a schematic illustration showing a side view of a communication device being constructed according to aspects described herein.

FIG. 1f is a schematic illustration showing a side view of a communication device being constructed according to aspects described herein.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following description sets forth exemplary embodiments of the present disclosure. It should be recognized, however, that such description is not intended as a limitation on the scope of the present disclosure. Rather, the description also encompasses combinations and modifications to those exemplary embodiments described herein.

The present disclosure relates to methods and constructions for producing a construction including a communication device. Conventional communication devices, such as radio-frequency identification (RFID) tags, typically include a carrier that supports an antenna and other components. Typically, such carriers are made of a PET film. However, these carriers may add cost, bulk, and complexity to the final product.

Communication devices are understood to include devices that utilize wireless technology to communicate with another device. Examples include but are not limited to ultra-high frequency (UHF), near-field communication (NFC), bluetooth low energy (BLE), long-term evolution (LTE), and electronic article surveillance (EAS) inlays. Communication devices may include passive or active devices. Passive devices do not include an internal power source and are powered by electromagnetic energy transmitted from a reader. Different types of passive tags operate on different frequencies. Active devices, including an internal power source, continuously broadcast their own signal.

The methods and constructions described herein utilize an elastomeric carrier during the manufacturing process to create a construction including a communication device. The elastomeric carrier may be temporarily employed to support the formation of the communication device components, and then removed through a stretching process, leaving behind a construction including a communication device. By eliminating the need for a permanent communication device carrier, the resulting communication device may be at least one of thinner, more flexible, and more cost-effective to produce. Additionally, the use of an elastomeric carrier during manufacturing may eliminate the need for a release layer or release liner, overcoming manufacturing complications arising from de-wetting of an adhesive on a low surface energy release surface including, for example, a silicone or fluorocarbon. The absence of a permanent carrier may allow for improved integration of the communication device into various products, such as labels or packaging, without adding significant bulk. This is advantageous, as it allows for the use of a communication device on a label without negatively impacting the aesthetics of the label, due to the small thickness of the communication device.

The elastomeric carrier used in the manufacturing of the communication device may be made of an elastomer film. By "elastomers" is meant herein polymers with viscoelastic properties, characterized by their ability to undergo significant stretching and then recover to their original shape with minimal deformation. This unique property of elastomers makes them particularly suitable for use as a carrier in the production of carrier-free communication devices. The molecular structure of elastomers may be described as a network of long polymer chains with weak intermolecular forces, allowing for considerable molecular reconfiguration without breaking covalent bonds. By "elastomeric" is meant herein a material including an elastomer, and that exhibits high elasticity, such that it can stretch and deform significantly under stress and then return to its original shape when the stress is removed. Elastomeric materials may exhibit a low Young's modulus, i.e. less than or equal to 2.0 GPa, and high failure strain compared to other polymeric materials. In some embodiments, the elastomeric carrier may be composed of materials such as natural rubber, synthetic rubber, or thermoplastic elastomers. In some embodiments, the elastomeric carrier may be adapted to receive the adhesive and release adhesive when deformed. In some embodiments, the elastomeric carrier may be adapted to enable proper adhesive film formation when an adhesive is deposited onto the carrier surface. In some embodiments, the elastomeric carrier may be selected based on its compatibility with an adhesive that is to be deposited on the elastomeric carrier. Factors such as surface energy, chemical resistance, and thermal stability may be considered when choosing an appropriate elastomeric material for the carrier.

In some embodiments, the elastomeric carrier may be deformed by stretching. The elastomeric carrier may be stretchable. By "stretchable," "stretchy" or elastic is meant herein, capable of being stretched and able to return to its original size and shape after being stretched. In some embodiments, the elastomeric carrier may be stretched in the machine direction. In some embodiments, the elastomeric carrier may be stretched in the cross direction. In some embodiments, the elastomeric carrier may be stretched in both the machine direction and the cross direction. The elastomeric carrier may be stretched using any suitable method that applies a force. These methods may include for example, mechanical stretching devices, rollers with different rotational speeds, or other techniques that apply tension to the elastomeric film. The specific stretching method may be selected based on factors such as the elastomeric material properties, desired stretching ratio, and production speed requirements. The ability of the elastomeric carrier to be stretched significantly and then recover to its original shape with minimal deformation that may allow for the carrier to be reused multiple times in the manufacturing process. This reusability may contribute to cost-effectiveness and sustainability in the production of communication devices. In some embodiments, after stretching, the elastomeric carrier relaxes by removal or reduction of the applied force.

The methods described herein relate to making a construction including a communication device on an elastomeric carrier. The construction, including the antenna, may be assembled on the elastomeric carrier and subsequently released by stretching the elastomeric carrier to cause debonding.

In some embodiments, the method of making a communication device may include depositing a first adhesive onto a first surface of the elastomeric carrier. In some cases, the first adhesive may be deposited in the shape of an antenna or deposited in substantially in the shape of an antenna. The deposition of the first adhesive may be accomplished through any suitable method, such as for example, printing (e.g. screen printing, flexographic printing, gravure printing, or inkjet printing) or coating. In some embodiments the adhesive may be accomplished by at least one of printing and coating. The choice of adhesive deposition technique may depend on factors such as the viscosity of the first adhesive, the desired resolution of the antenna pattern, and the production volume requirements.

The composition of the first adhesive may vary depending on the specific requirements of the communication device. In some embodiments, the first adhesive may include a polymer-based material. Examples of suitable polymers for the first adhesive may include acrylic polymers, polyurethanes, epoxy resins, or silicone-based adhesives. The specific polymer composition may be selected based on factors such as adhesion strength, flexibility, and compatibility with the elastomeric carrier and conductive film used for the antenna.

After deposition, the first adhesive may undergo a solidification process. This solidification may be achieved through any suitable method. In some cases, solidifying the first adhesive may comprise at least one of UV curing and drying the adhesive. UV curing may involve exposing the first adhesive to ultraviolet light, which initiates a polymerization reaction, resulting in the solidification of the adhesive. Drying may involve the evaporation of solvents from the first adhesive, leaving behind a solid adhesive layer. The solidified first adhesive layer provides a stable surface to which the conductive film forming the antenna can be applied, for example by lamination. The adhesive layer may also help to maintain the shape and integrity of the antenna during subsequent manufacturing steps and in the final communication device.

In some embodiments, the first adhesive may have a stretchiness that is less than the stretchiness of the elastomeric carrier. This difference in stretchiness may facilitate the debonding process during the stretching of the elastomeric carrier. Preferably, the debonding may occur in through a controlled and non-destructive release mechanism. The stretchiness of materials may be measured using any suitable method. In some cases, stretchiness may be quantified through elongation tests, where a sample of the material is stretched until failure. The elongation at break, expressed as a percentage, may provide a measure of the material's stretchiness. Materials with higher elongation at break values may be considered stretchier. In some embodiments, the first adhesive has an elongation at break that is less than the elongation at break of the elastomeric carrier. In some cases, stretchiness may be characterized by the elastic modulus or Young's modulus of a material. This parameter may be determined through tensile testing, where the stress-strain relationship of the material is analyzed. Materials with lower elastic moduli may generally exhibit greater stretchiness. In some embodiments, the first adhesive has an elastic modulus that is greater than the elastic modulus of the elastomeric carrier.

The first adhesive may form a temporary bond with the elastomeric carrier. The bond may be strong enough to withstand subsequent processing steps, yet weak enough to allow for controlled debonding when the elastomeric carrier is stretched. In some cases, the first adhesive layer may be configured to undergo crack propagation when the elastomeric carrier is stretched. This crack propagation may facilitate the separation of the first adhesive from the elastomeric carrier during the communication device manufacturing process. This crack propagation in the first adhesive does not cause delamination or splitting from the antenna. In some embodiments, the protective film is sufficiently rigid that it resists stretching when the elastomeric carrier is stretched. Accordingly, the debond may occur through a non-destructive release mechanism.

After the first adhesive is deposited on the elastomeric carrier, a conductive film may be disposed onto the first adhesive. The conductive film may be laminated onto the first adhesive. The conductive film is electrically conductive. The conductive film may also be thermally conductive. The conductive film may be made of any suitable material that is capable of conducting an electrical current. In some cases, the conductive film may comprise aluminum, copper, silver, or conductive polymers. The choice of material may depend on factors such as conductivity, cost, and ease of processing. Aluminum may be chosen for its conductivity, cost-effectiveness, and ease of processing. In some embodiments, the conductive film may be a laminate structure. In some embodiments, the conductive film may be a metal that is laminated to a plastic, forming, for example, an aluminum-PET (polyethylene terephthalate) laminate or an aluminum-BOPP (biaxially oriented polypropylene) laminate. The conductive film may have a thickness ranging from 0.5 μm to 100 μm, e.g., from 1 μm to 80 μm, from 1.5 μm to 75 μm or from 2 μm to 50 μm. As used herein, the thickness refers to the average thickness of the material. Generally, the layers are uniform or substantially uniform in thickness and small variations in thickness are not detrimental to the manufacturing methods described herein. Combinations of conductive film may also be employed to achieve desired electrical and mechanical properties. Aluminum, for example, offers excellent electrical conductivity for ultra-high frequency (UHF) antenna applications.

Although a conductive film may be used to form the antenna, in some embodiments a conductive ink may be employed. The conductive ink may comprise one or more conductive materials, including aluminum, silver, copper, graphene, or combinations thereof. When a conductive ink is used, the electrical conductivity and performance characteristics of an antenna having a given geometry may be adjusted by varying the composition of the ink, such as by modifying a ratio of conductive material to non conductive binder or carrier material. The conductive ink may be deposited using any suitable printing or coating technique, including inkjet printing, screen printing, flexographic printing, gravure printing, or other printing processes. In some embodiments, after deposition of the conductive ink, a cutting or patterning step may be performed to define the antenna geometry. The conductive ink may be printed or deposited directly in a desired antenna pattern such that a separate cutting step is omitted. Conductive inks may be selected to provide flexibility in antenna design, compatibility with roll to roll processing, and potential cost efficiencies for large scale production.

The conductive film may be cut to form the shape of an antenna. The cutting process may be performed using any suitable method, including but not limited to die-cutting, laser cutting, or other suitable patterning techniques including stamping, etching, or related methods. In some cases, the cutting may be performed by die-cutting. Die-cutting may allow for precise and consistent shaping of the antenna. The die-cutting process may involve using a custom-made die that matches the desired antenna shape, which is pressed against the conductive film to cut out the antenna pattern.

After the cutting process, excess conductive film may be removed from around the antenna. This removal process may ensure that only the desired antenna pattern remains on the first adhesive. The removal of excess material may be performed through any suitable methods, such as for example mechanical separation or vacuum extraction.

The resulting antenna may be positioned within the device structure such that it is sandwiched between the elastomeric film and other layers of the construction, such as a protective film. In some embodiments, the antenna is sandwiched between the elastomeric film and a second adhesive coated on a surface of a protective film. Accordingly, the second adhesive adheres the elastomeric film to the protective film. This positioning may help protect the antenna and maintain its shape and functionality within the final communication device.

In some cases, a plurality of antennas are formed on the elastomeric carrier, allowing for the creation of multiple communication devices in a single manufacturing process. The plurality of antennas may be arranged in a specific pattern or array on the elastomeric carrier 1, which may facilitate efficient production and subsequent separation of individual communication devices. Further, this enables the arrangement of multiple communication devices, on pitch, on a label construction.

The shape and design of the antenna may vary depending on the specific requirements of the communication device. The antenna may be designed to operate at specific frequencies or to have particular radiation patterns. The cutting process may be adapted to create various antenna shapes, such as dipole antennas, loop antennas, or more complex patterns, depending on the intended application of the communication device.

The communication device includes the antenna and a chip. Although the chip may be attached or mounted to the conductive film prior to cutting, it is preferred to attach or mount the chip after cutting to prevent damage to the chip. The chip may be electrically connected to the antenna to enable communication between the chip and external devices or systems. The chip may be attached to the antenna by any suitable means. The chip may be directly attached to the antenna, or indirectly attached to the antenna, for example via a strap. In some embodiments, the chip is directly attached to the antenna by an adhesive.

The chip may be located on a surface of the antenna opposite the first adhesive. In some cases, the chip and the antenna may be protected by the protective film, which covers them.

In some embodiments, the chip may be operatively coupled to the antenna. In some embodiments, the chip is bonded directly to designated contact pads or regions on the antenna using conductive adhesives, solder bumps, anisotropic conductive films, or other suitable interconnect technologies. This direct-attach approach reduces component count, minimizes assembly steps, and can improve electrical performance by lowering contact resistance and parasitic inductance. Additionally, direct chip-to-antenna integration may enable a thinner, more compact construction, which is advantageous for applications requiring ultra-low-profile tags.

In some embodiments, the antenna includes one or more connection pads, terminals, or contact regions configured to electrically interface with the chip. The chip may be positioned on a surface of the antenna opposing the first adhesive layer. Positioning may be performed using automated pick-and-place equipment configured to align the chip with the antenna contact regions with a predetermined positional tolerance. In some embodiments, electrical testing may be performed after chip attachment to verify antenna continuity, chip functionality, or impedance matching between the chip and the antenna.

To achieve size reductions and to enable low profile antennas, the straps may be used to operatively interconnect antennas with the chip. In some embodiments, the strap includes conductive leads or contact pads that are electrically coupled to the chip’s terminals, thereby providing a reliable interface for signal transmission. These conductive pads offer a larger effective contact area compared to direct chip bonding, which reduces alignment precision requirements during assembly and improves manufacturing throughput. By minimizing the need for high-accuracy placement, strap-based interconnection supports high-speed, automated production processes while maintaining robust electrical performance. Additionally, straps can incorporate features such as pre-applied conductive adhesives or solder bumps to further streamline assembly and enhance connection reliability.

The chip may contain various electronic components and circuitry necessary for the operation of the communication device. In some embodiments, the chip may include memory for storing data, a processor for processing information, and communication interfaces for interacting with external devices or systems. The specific functionality of the chip may vary depending on the intended application of the communication device. In some embodiments, the chip may be an integrated circuit chip. The chip may comprise a logic unit that makes decisions and/or memory to store data, such as tag ID, object identifier, passwords, etc. The chip may be configured for use in an active RFID device or a passive RFID device. Chips may be fabricated from semiconductor wafers, and any suitably sized chip may be used with the embodiments disclosed herein. In some embodiments, the chip may be encoded with information relating to a product with which the RFID device is to be associated. Encoding may be performed before placement of the chip on the antenna or after placement.

In some cases, the chip may be designed to operate in conjunction with the antenna to enable radio frequency identification (RFID) capabilities. The chip may store a unique identifier and other relevant information that can be transmitted when the communication device is activated by an external reader.

The attachment of the chip to the conductive film forming the antenna may be performed at various stages of the manufacturing process. In some embodiments, the chip may be attached to the antenna after the conductive film has been cut to form the antenna. In some embodiments, the chip may be attached to the conductive film before the cutting process, with appropriate measures taken to protect the chip during subsequent manufacturing steps.

The method of attaching the chip to the conductive film may vary depending on factors such as the size of the chip, the material of the conductive film, and the desired electrical and mechanical properties of the connection. In some cases, the attachment may involve the use of conductive adhesives, which may provide both electrical connectivity and mechanical bonding. In other cases, soldering techniques may be employed to create a robust electrical connection between the chip and the antenna.

The positioning and attachment of the chip may be designed to withstand the stretching process of the elastomeric carrier. In some embodiments, the chip and its connection to the antenna may be configured to maintain integrity during the debonding process when the elastomeric carrier is stretched.

The construction also includes a protective film, such as for example, a facestock material that may comprise any suitable material, such as for example paper, flexible fabric material, plastic, composite materials, PET, or BOPP. The specific composition of the protective film may be selected based on factors such as durability, printability, and compatibility with the other components of the communication device. The protective film may be disposed onto the first surface of the elastomeric carrier. The protective film may be made of any suitable material. In some embodiments, the protective film may be a thin, flexible material that serves as the outermost layer of the communication device construction. The protective film may be a monolayer or multilayer. The thickness of the protective film may vary, and in some embodiments, the protective film may have a thickness from 0.5 µm to 50 µm, e.g., from 0.5 µm to 25 µm, from 0.5 µm to 10 µm, from 0.7 µm to 5 µm, or more preferably from 1 µm to 4.5 µm. In other embodiments, the protective film may be thicker without departing from the scope of the present disclosure.

The protective film may have a second adhesive coating on one of its surfaces. This second adhesive may serve to adhere the protective film to other components of the communication device. The composition of the second adhesive may depend on factors such as adhesion strength, flexibility, and compatibility with the protective film material and other components of the communication device. The second adhesive may be a pressure sensitive adhesive that is configured to bond the construction to an article. Any suitable adhesive may be used, such as for example acrylic-based adhesives, silicone adhesives, or rubber-based adhesives. The second adhesive may be applied by printing, coating, or spraying, either across the entire surface of the protective film or selectively applied in a pattern on the surface of the protective film.

When the protective film is disposed onto the first surface of the elastomeric carrier, the antenna may be sandwiched between the protective film and the elastomeric carrier. This arrangement may help protect the antenna and maintain its position within the communication device structure.

In some cases, the protective film may have a printable surface opposite to the second adhesive coating. This printable surface may allow for the addition of visual information associated with the RFID label or tag, such as product identification, branding, or tracking data. The printable surface may be designed to be compatible with various printing technologies, such as thermal transfer, inkjet, or laser printing.

An important feature of the protective film may be that the antenna is not visible through the printable surface of the protective film. This characteristic may be achieved through the selection of appropriate materials and thicknesses for the protective film. The opacity or translucency of the protective film may be controlled to ensure that the antenna remains hidden from view when looking at the printable surface. This feature may be particularly beneficial in applications where the aesthetics of the communication device are important, or where the visibility of the antenna may be undesirable for security, aesthetic or design reasons.

The protective film may function to provide support and structural integrity in the final structure of the carrier-free communication device. By providing a stable outer layer and helping to secure the internal components, the protective film may enable the creation of a functional communication device without the need for a permanent carrier. This may result in a thinner, more flexible, and potentially more cost-effective communication device compared to traditional designs that incorporate a permanent carrier.

After the construction has been assembled on the elastomeric carrier, the elastomeric carrier is stretched. In some embodiments, the stretching of the elastomeric carrier causes the communication device to detach from the elastomeric carrier. In some embodiments, stretching of the elastomeric carrier causes the first adhesive to debond from the elastomeric carrier. In some embodiments, the first adhesive layer may be configured to undergo crack propagation when the elastomeric carrier is stretched. In some embodiments, such stretching may also cause at least a portion of the second adhesive to debond from the elastomeric carrier, in which a portion of the second adhesive may also undergo crack propagation. Accordingly, the stretching may cause both the first and second adhesive, or portions thereof, to debond upon stretching. The stretching of the elastomeric carrier may be conducted by any suitable method as described herein.

The use of an elastomeric carrier to detach the communication device from the elastomeric carrier may enable the manufacturing of labels with multiple communication devices oriented on-pitch. "On-pitch orientation" refers herein to the precise spacing and alignment of communication devices on the label substrate. This may be achieved through the controlled stretching and relaxation of the elastomeric carrier, allowing for accurate positioning of the communication device components during the manufacturing process. In some embodiments, the method comprises relaxing the elastomeric carrier after debonding of the first adhesive, which may allow the elastomeric carrier to be reused. The plurality of antennas may be arranged in a specific pattern or array on the elastomeric carrier, which may facilitate efficient production and subsequent separation of individual communication devices by cutting the label film.

The use of the elastomeric carrier may also facilitate the production of thinner and more flexible communication devices by eliminating the need for a permanent carrier. This may result in improved integration of the communication device into various products, such as labels or packaging, without adding significant bulk or compromising aesthetics. This may result in more consistent and predictable transfer of antennas and other components to the final substrate, addressing challenges associated with poor film formation on release-coated liners.

In some embodiments, the method of making a construction including a communication device includes depositing a first adhesive onto a first surface of an elastomeric carrier, wherein the first adhesive is deposited in the shape of an antenna; disposing a conductive film onto the first adhesive; cutting the conductive film to form a shape of an antenna; disposing a protective film onto the first surface of the elastomeric carrier, thereby sandwiching the antenna between the elastomeric film and a second adhesive coated on a surface of the protective film; and stretching the elastomeric carrier. In some embodiments, stretching of the elastomeric carrier causes the first adhesive to debond from the elastomeric carrier. In some embodiments, such stretching may also cause at least a portion of the second adhesive to debond from the elastomeric carrier. Accordingly, the stretching may cause both the first and second adhesive, or portions thereof, to debond upon stretching.

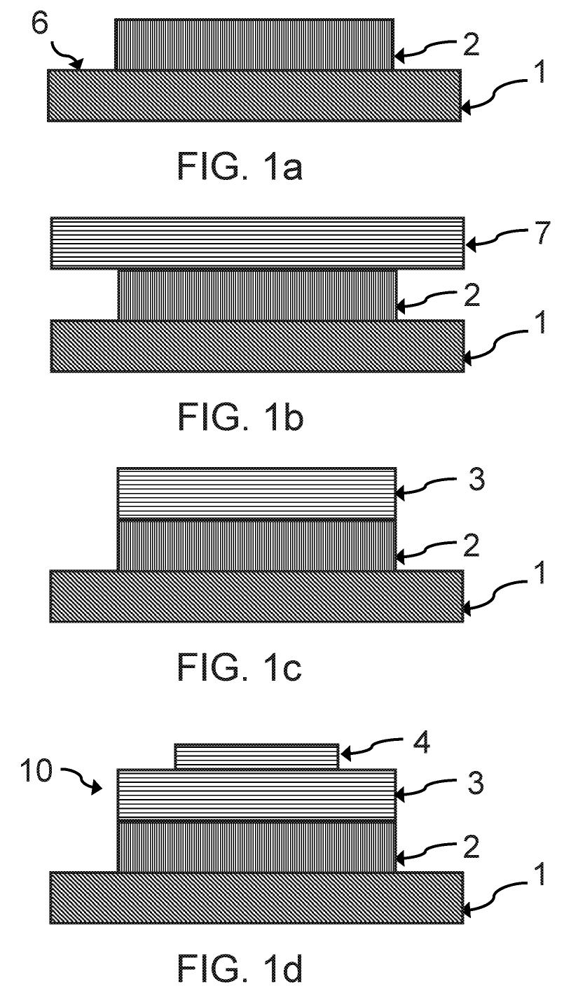

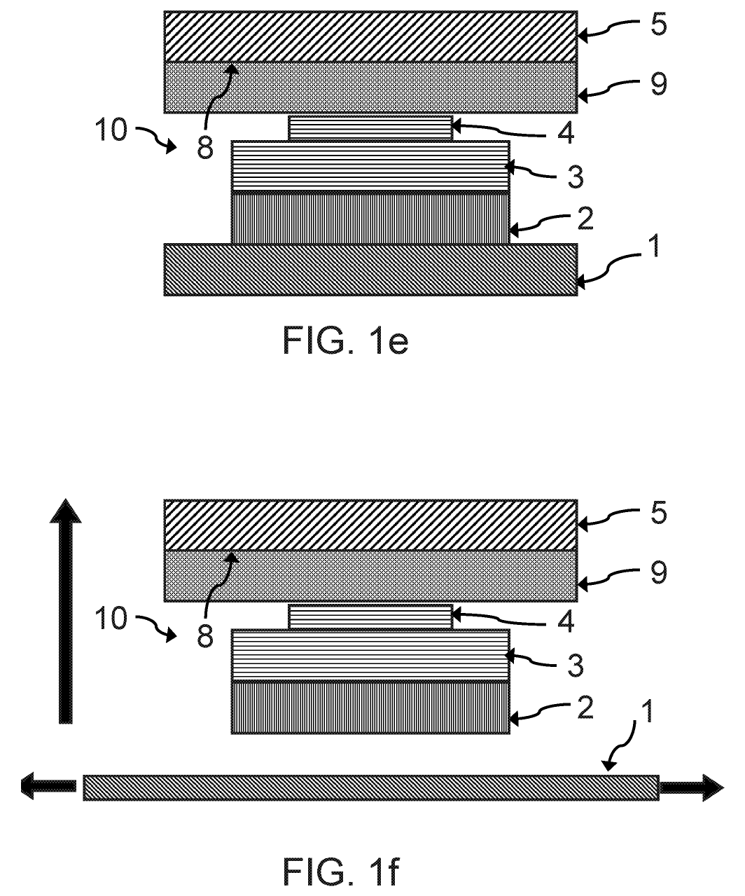

FIG. 1a shows an illustration of a first adhesive 2 deposited onto a first surface 6 of an elastomeric carrier 1. The first adhesive 2 may be deposited in the shape of an antenna or in a shape substantially similar to the antenna. In some embodiments, the first adhesive 2 may be solidified. FIG. 1b shows a conductive film 7 disposed onto the solidified first adhesive 2. FIG. 1c shows the conductive film that has been cut to form the shape of the antenna 3. FIG. 1d shows a chip 4 attached to the antenna 3, forming a communication device 10. FIG. 1e shows a protective film 5 having a second adhesive coating 9 coated on its surface 8, with the communication device 10 sandwiched between the second adhesive 9 coated on a surface 8 of the protective film 5 and the first adhesive 2 on the elastomeric carrier 1. FIG. 1f shows the elastomeric carrier 1 that has been separated from the construction 11 after the first adhesive 2 has debonded from the elastomeric carrier 1. In some embodiments, a portion of the second adhesive 9 may also contact the elastomeric carrier 1. Upon stretching of the elastomeric carrier 1 a portion of the second adhesive 9 may also be debonded from the elastomeric carrier 1.

Another aspect of the present disclosure relates to a construction including a communication device. The communication device includes an antenna and a chip. In some embodiments, a first adhesive layer supports the antenna on the side of the antenna that is opposite to the chip. The construction further includes a protective film that is coated on one side with a second adhesive. The first adhesive is disposed on an elastomeric carrier. In some embodiments, the communication device is sandwiched between the second adhesive on the protective film and the elastomeric carrier. In one embodiment, the first adhesive may be configured to debond from the elastomeric carrier upon stretching of the elastomeric carrier. In one embodiment, a portion of the second adhesive may also be configured to debond from the elastomeric carrier upon stretching of the elastomeric carrier. The elastomeric carrier may be stretched by any suitable means, as described hereinabove.

In some embodiments, the construction includes a communication device including an antenna and a chip; a first adhesive layer supporting the antenna; and a protective film having a second adhesive coating; wherein the communication device is sandwiched between the second adhesive on the protective film and the elastomeric carrier; and wherein the first adhesive layer is configured to debond from the elastomeric carrier upon stretching of the elastomeric carrier. Preferably the first adhesive may debond from the elastomeric carrier without rupture or debonding from the antenna. In some embodiments, such stretching may also cause at least a portion of the second adhesive to debond from the elastomeric carrier. Preferably the second adhesive may debond from the protective film without rupture or debonding from the antenna. Accordingly, the stretching may cause both the first and second adhesive, or portions thereof, to debond upon stretching.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. References to the singular are also intended to include the plural, unless the context clearly indicates otherwise.

A number of implementations have been described. Nevertheless, it will be understood that various modifications may be made without departing from the spirit and scope of the disclosure. Accordingly, other implementations are within the scope of the following claims. Features of any of the examples or embodiments outlined above may be combined to create additional examples or embodiments without losing the intended effect. It should be understood that the description of an embodiment or example provided above is by way of example only, and various modifications could be made by one skilled in the art. Furthermore, one skilled in the art will recognize that numerous further modifications and combinations of various aspects are possible. Accordingly, the described aspects are intended to encompass all such alterations, modifications, and variations that fall within the scope of the appended claims.

What is claimed is:

1. A method of making a construction including a communication device, comprising:
depositing a first adhesive onto a first surface of an elastomeric carrier, wherein the first adhesive is deposited in the shape of an antenna;
disposing a conductive film onto the first adhesive;
cutting the conductive film to form a shape of an antenna;
disposing a protective film onto the first surface of the elastomeric carrier, thereby sandwiching the antenna between the elastomeric film and a second adhesive coated on a surface of the protective film; and
stretching the elastomeric carrier to cause the first adhesive to debond from the elastomeric carrier.

2. The method of claim 1, wherein the elastomeric carrier is selected from the group consisting of natural rubber, synthetic rubber, or thermoplastic elastomers.

3. The method of claim 1, wherein the stretching of the elastomeric carrier causes a portion of the second adhesive to debond from the elastomeric carrier.

4. The method of claim 1, further comprising solidifying the first adhesive, wherein solidifying the first adhesive comprises at least one of UV curing and drying the first adhesive.

5. The method of claim 1, further comprising attaching a chip to the antenna.

6. The method of claim 1, wherein the elastomeric carrier is stretched in at least one of the machine direction and the cross direction.

7. The method of claim 1, wherein the protective film comprises a printable surface opposite to the second adhesive coating, wherein the antenna is not visible through the printable surface of the protective film.

8. A construction, comprising:
a communication device comprising an antenna and a chip,
a first adhesive layer supporting the antenna, and
a protective film having a second adhesive coating,
wherein the communication device is sandwiched between the second adhesive on the protective film and the elastomeric carrier; and
wherein the first adhesive layer is configured to debond from the elastomeric carrier upon stretching of the elastomeric carrier.

9. The construction of claim 8, wherein a portion of the second adhesive coating is configured to debond from the elastomeric carrier upon stretching of the elastomeric carrier.

10. The construction of claim 8, wherein the antenna comprises aluminum, copper, silver, or conductive polymers.

11. The construction of claim 8, wherein the construction is carrier-free.

12. The construction of claim 8, wherein the first adhesive layer is configured to undergo crack propagation when the elastomeric carrier is stretched.

13. The construction of claim 8, wherein the protective film comprises a printable surface opposite to the second adhesive coating, wherein the protective film is sufficiently rigid that it resists stretching when the elastomeric carrier is stretched.

14. A method of making a construction including a communication device, comprising:
depositing a first adhesive onto a first surface of an elastomeric carrier, wherein the first adhesive is deposited in the shape of an antenna;
solidifying the first adhesive, wherein solidifying the first adhesive comprises at least one of UV curing and drying the first adhesive;
forming an antenna on the solidified first adhesive;
disposing a protective film onto the first surface of the elastomeric carrier, thereby sandwiching the antenna between the elastomeric film and a second adhesive coated on a surface of the protective film; and
stretching the elastomeric carrier to cause the first adhesive to debond from the elastomeric carrier.

15. The method of claim 14, wherein the elastomeric carrier is selected from the group consisting of natural rubber, synthetic rubber, or thermoplastic elastomers.

16. The method of claim 14, wherein the stretching of the elastomeric carrier causes a portion of the second adhesive to debond from the elastomeric carrier.

17. The method of claim 14 wherein the antenna is formed by:
disposing a conductive film onto the first adhesive; and
cutting the conductive film to form a shape of an antenna.

18. The method of claim 14 wherein the antenna is formed by deposited a conductive ink.

19. The method of claim 14, wherein the elastomeric carrier is stretched in at least one of the machine direction and the cross direction.

20. The method of claim 14, wherein the protective film comprises a printable surface opposite to the second adhesive coating, wherein the antenna is not visible through the printable surface of the protective film.
